(19) United States
(12) Patent Application Publication
(10) Pub. No.: US 2003/0196744 A1
(43) Pub. Date: Oct. 23, 2003

(54) Apparatus and method for laminating three-dimensional surfaces

(76) Inventor: Philip Sicola, Seal Beach, CA (US)

Correspondence Address: DAVID A. BELASCO, ESQ., BEEHLER & PAVITT, 100 Corporate Pointe, Suite 330, Culver City, CA, 90230, US

(21) Appl. No.: 10/039,817

(22) Filed: Apr. 23, 2002

(51) Int. Cl. B32B 31/00

(52) U.S. Cl. 156/214; 156/285; 156/382; 156/475

(57) ABSTRACT

An apparatus for laminating three-dimensional surfaces includes a formed of rigid material that has an upper surface, a lower surface and a first perimeter. Three-dimensional features are formed in the substrate, commencing at the upper surface, and extending downwardly toward the lower surface. A veneer formed of thin, resilient material having a top surface and a bottom surface is prepared and glue suitable for adhering the veneer to the substrate is applied to its bottom surface. The veneer is positioned on the substrate and pressure is applied to the top surface of the veneer to conform the veneer to the substrate. When the glue has dried, the veneer will be adhered to the upper surface of the substrate and will reflect the three-dimensional features of the substrate. The three-dimensional features of the substrate are produced by manual carving of the upper surface, by application of powered rotary cutting and grinding tools, or by computer-controlled contouring machinery. The substrate material is wood, particleboard, chipboard, plastic, metal or cellular material and the veneer material is either wood, burl wood, plastic and metal. Pressure is applied to the top surface of the veneer using an airtight, flexible container that has a sealable opening sized and shaped to admit the substrate with the veneer located upon it. When the air is evacuated from the container, atmospheric pressure will conform the veneer to the upper surface of the substrate.

### FIELD OF THE INVENTION

The invention pertains to laminating techniques. More particularly, the invention relates to equipment and methods for laminating veneers to hand or machine carved three-dimensional substrates.

### BACKGROUND OF THE INVENTION

Various types of machines and methods have been developed for laminating veneers and similar materials onto substrate surfaces; incorporating a number of different technologies. U.S. Pat. No. 5,716,488 issued to Bryant is directed to a reusable vacuum bag for making laminated articles wherein the bag is evacuated after layers with applied thermosetting resin are stacked upon a forming surface of a forming tool. After the bag has been evacuated, the plastic bag sheet portion of the bag is firmly pressed against the forming tool, thus forming the materials to the shape of the forming surface.

U.S. Pat. No. 4,447,282 issued to Valerio et al., describes a process and equipment for a veneer press to glue a thin layer on a variously shaped panel surface. The veneer is formed by gluing a thin wood layer to a panel. A flexible rubber sheet is placed over the thin wood layer is sealed by means of lower plate in order to form a chamber. Where a vacuum is formed between the lower plate and the flexible rubber sheet, a resultant external pressure causes the thin wood layer to be adhered to the panel conforming to the shape of panel.

U.S. Pat. No. 5,401,349, issued to Goetz et al. is directed to the production of shaped articles and utilizes a technique that includes “vacuum bagging”. The process involves placing prepreg laminates onto a support surface and then covering the laminates with a gas impermeable film. When the space between the support surface and the cover film is evacuated, and the system raised to some elevated temperature, a laminated shaped article is formed.

U.S. Pat. No. 6,242,078 B1 issued to Pommer et al. describes a high-density printed circuit substrate and a method of fabrication. The use of an evacuated plastic bag is part of the procedure for processing polymer-coated base laminates. The Patent describes the process wherein the vacuum is applied to the book using either a vacuum enclosed press or by placing each laminate in a sealable bag and drawing a vacuum on the individual laminate during the press cycle.

U.S. Pat. No. 6,152,840 issued to Baum is directed to a composite baseball bat with a cavitied core. The bat is produced by first shaping a plank into a semi-cylindrical configuration to form a preform. In order to do this, the plank is saturated with a liquid solvent and then shaped into the semi-cylindrical form in either matched dies or one die using a vacuum bag to pressure the plank against the die as the plank is heated to drive off the solvent. While other variations exist, the above-described designs for laminating veneers and similar materials onto substrate surfaces are typical of those encountered in the prior art.

It is an objective of the present invention to provide an apparatus and method for laminating veneers and similar materials onto substrates having three-dimensional surface features. It is a further objective to provide such capabilities without requiring the creation of special custom forms and supports. It is a still further objective of the invention to provide the above-described capabilities in a manner that minimizes the risk of damaging the veneer or related material during the laminating process. It is yet a further objective to provide methods that may be used with a wide variety of laminating materials in an inexpensive and durable machine which is capable of extended duty cycles and that may be easily repaired and maintained.

While some of the objectives of the present invention are disclosed in the prior art, none of the inventions found include all of the requirements identified.

### SUMMARY OF THE INVENTION

The present invention addresses all of the deficiencies of prior art apparatus and methods for laminating three-dimensional surfaces and satisfies all of the objectives described above.

An apparatus for laminating three-dimensional surfaces providing the desired features may be constructed from the following components. A substrate is provided. The substrate is formed of rigid material and has an upper surface, a lower surface and a first perimeter. Means are provided for forming three-dimensional features, commencing at the upper surface, that extend downwardly toward the lower surface. A veneer is provided. The veneer is formed of thin, resilient material and has a top surface and a bottom surface.

Glue is provided. The glue is suitable for adhering the veneer to the substrate and is applied to the bottom surface of the veneer. The veneer is positioned upon the substrate. Means are provided for applying pressure to the top surface of the veneer to conform the veneer to the substrate. When the glue has dried, the veneer will be adhered to the upper surface of the substrate and will reflect the three-dimensional features of the substrate.

In a variant of the invention, the three-dimensional features of the substrate are produced by manual carving of the upper surface of the substrate. In another variant, the three-dimensional features of the substrate are produced by application of powered rotary cutting and grinding tools to the upper surface of the substrate. In yet another variant, the three-dimensional features of the substrate are produced by computer-controlled contouring machinery.

In a further variant of the invention, the substrate material is selected from the group comprising: wood, particleboard, chipboard, plastic, metal and cellular materials. In yet a further variant, the veneer material is selected from the group comprising: wood, burl wood, plastic and metal.

In another variant, the means for applying pressure to the top surface of the veneer to conform it to the substrate includes an airtight, flexible container. The flexible container has a sealable opening sized and shaped to admit the substrate with the veneer located upon it. Means are provided for evacuating the air from the container. When the substrate with the veneer located upon it is inserted into the container, the container sealed, and the air evacuated from the container, atmospheric pressure will conform the veneer to the upper surface of the substrate.

A method for laminating three-dimensional surfaces includes the following steps. Providing a substrate. The substrate is formed of rigid material and has an upper surface, a lower surface and a first perimeter. Forming three-dimensional features commencing at the upper surface of the substrate. The three-dimensional features extend downwardly toward the lower surface. Providing a veneer. The veneer is formed of thin, resilient material and has a top surface and a bottom surface. Applying glue to the bottom surface of the veneer that is suitable for adhering the veneer to the substrate. Positioning the veneer upon the substrate. Applying pressure to the top surface of the veneer to conform the veneer to the substrate. When the glue has dried, the veneer will be adhered to the upper surface of the substrate and will reflect the three-dimensional features of the substrate.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a perspective view of a substrate having three-dimensional upper surface features;

FIG. 2 is a ride elevation of the substrate with a veneer positioned above the upper surface;

FIG. 3 is a side elevation of the preferred embodiment of the invention illustrating the substrate and veneer inside of a vacuum bag with the bag being evacuated by a vacuum pump;

FIG. 4 is a perspective view of the three-dimensional features of the upper surface of the substrate being carved with a hand tool;

FIG. 5 is a perspective view of the three-dimensional features of the upper surface of the substrate being carved with an hand-held power tool; and

FIG. 6 is a perspective view of the three-dimensional features of the upper surface of the substrate being carved with a three-axis machine tool.

### DETAILED DESCRIPTION OF THE PREFERRED EMBODIMENT

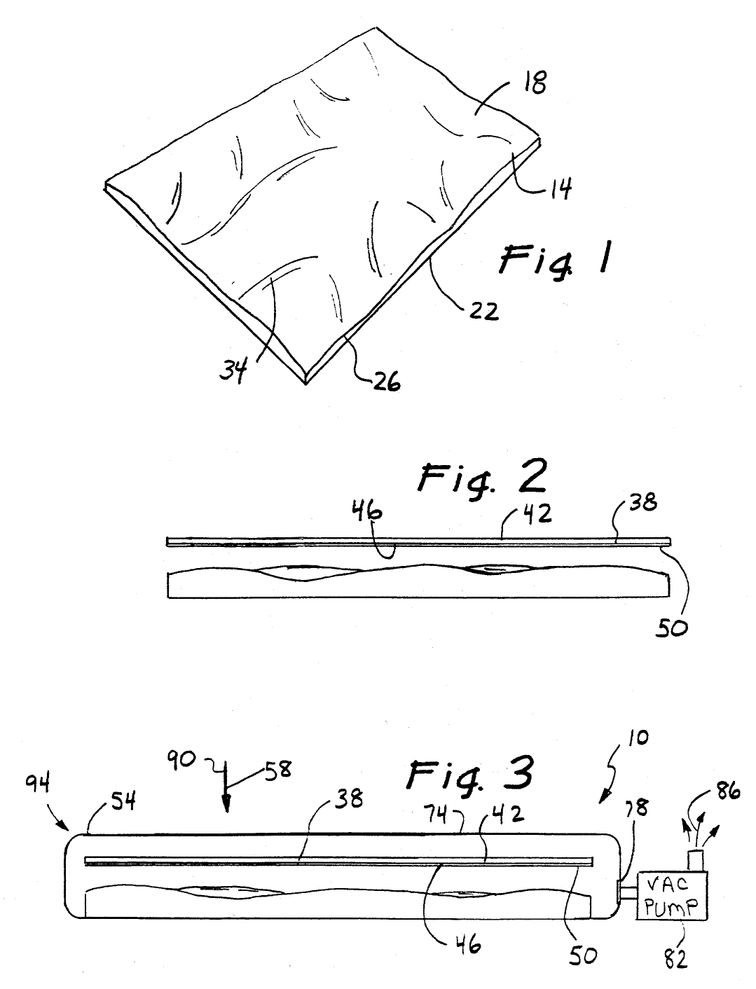

FIGS. 1-6 illustrate an apparatus for laminating three-dimensional surfaces 10. The apparatus 10 includes the following components. A substrate 14 is provided. The substrate 14 is formed of rigid material and has an upper surface 18, a lower surface 22 and a first perimeter 26. Means 30 are provided for forming three-dimensional features 34, commencing at the upper surface 18, that extend downwardly toward the lower surface 22. A veneer 38 is provided. The veneer 38 is formed of thin, resilient material and has a top surface 42 and a bottom surface 46.

Glue 50 is provided. The glue 50 is suitable for adhering the veneer 38 to the substrate 14 and is applied to the bottom surface 46 of the veneer 38. The veneer 38 is positioned upon the substrate 14. Means 54 are provided for applying pressure 58 to the top surface 42 of the veneer 38 to conform the veneer 38 to the substrate 14. When the glue 50 has dried, the veneer 38 will be adhered to the upper surface 18 of the substrate 14 and will reflect the three-dimensional features of the substrate 14.

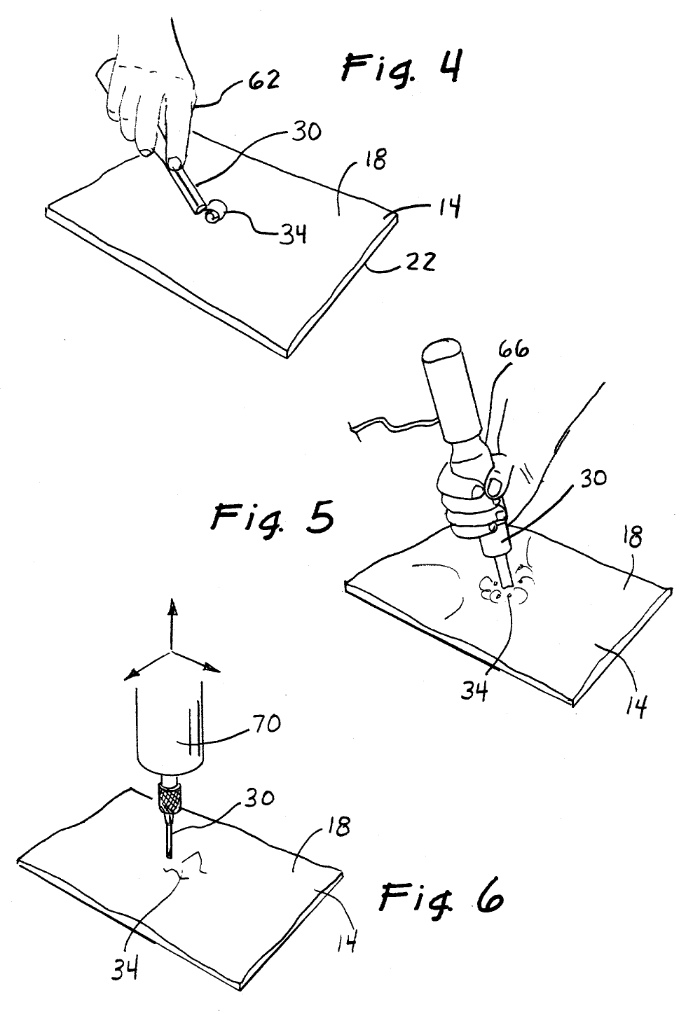

In a variant of the invention, as illustrated in FIG. 4, the three-dimensional features 34 of the substrate 14 are produced by manual carving 62 of the upper surface 18 of the substrate 14. In another variant, as illustrated in FIG. 5, the three-dimensional features 34 of the substrate 14 are produced by application of powered rotary cutting and grinding tools 66 to the upper surface 18 of the substrate 14. In yet another variant, as illustrated in FIG. 6, the three-dimensional features 34 of the substrate 14 are produced by computer-controlled contouring machinery 70.

In a further variant of the invention, the substrate 14 material is selected from the group comprising: wood, particleboard, chipboard, plastic, metal and cellular materials. In yet a further variant, the veneer 38 material is selected from the group comprising: wood, burl wood, plastic and metal.

In another variant, as illustrated in FIG. 3, the means 54 for applying pressure 58 to the top surface 42 of the veneer 38 to conform it to the substrate 14 includes an airtight, flexible container 74. The flexible container 74 has a sealable opening 78 sized and shaped to admit the substrate 14 with the veneer 38 located upon it. Means 82 are provided for evacuating the air 86 from the container 74. When the substrate 14 with the veneer 38 located upon it is inserted into the container 74, the container 74 sealed, and the air 86 evacuated from the container 74, atmospheric pressure 90 will conform the veneer 38 to the upper surface 18 of the substrate 14.

A method, as illustrated in FIG. 3, for laminating three-dimensional surfaces 94 includes the following steps. Providing a substrate 14. The substrate 14 is formed of rigid material and has an upper surface 18, a lower surface 22 and a first perimeter 26. Forming three-dimensional features 34 commencing at the upper surface 18 of the substrate 14. The three-dimensional features 34 extend downwardly toward the lower surface 22. Providing a veneer 38. The veneer 38 is formed of thin, resilient material and has a top surface 42 and a bottom surface 46. Applying glue 50 to the bottom surface 46 of the veneer 38 that is suitable for adhering the veneer 38 to the substrate 14. Positioning the veneer 38 upon the substrate 14. Applying pressure 58 to the top surface 42 of the veneer 38 to conform the veneer 38 to the substrate 14. When the glue 50 has dried, the veneer 38 will be adhered to the upper surface 18 of the substrate 14 and will reflect the three-dimensional features 34 of the substrate 14.

The apparatus 10 and method 94 for laminating three-dimensional surfaces has been described with reference to particular embodiments. Other modifications and enhancements can be made without departing from the spirit and scope of the claims that follow.

1. An apparatus for laminating three-dimensional surfaces, comprising:
a substrate, said substrate being formed of rigid material, having an upper surface, a lower surface and a first perimeter;
means for forming three-dimensional features commencing at said upper surface, said three-dimensional features extending downwardly toward said lower surface;
a veneer, said veneer being formed of thin, resilient material and having a top surface and a bottom surface;
glue, said glue being suitable for adhering said veneer to said substrate and being applied to the bottom surface of said veneer;
said veneer being positioned upon said substrate;
means for applying pressure to the top surface of said veneer to conform said veneer to said substrate; and
whereby, when said glue has dried, the veneer will be adhered to the upper surface of the substrate and will reflect the three-dimensional features of the substrate.

2. An apparatus for laminating three-dimensional surfaces as described in claim 1, wherein the three-dimensional features of the substrate are produced by manual carving of the upper surface of the substrate.

3. An apparatus for laminating three-dimensional surfaces as described in claim 1, wherein the three-dimensional features of the substrate are produced by application of powered rotary cutting and grinding tools to the upper surface of the substrate.

4. An apparatus for laminating three-dimensional surfaces as described in claim 1, wherein the three-dimensional features of the substrate are produced by computer-controlled contouring machinery.

5. An apparatus for laminating three-dimensional surfaces as described in claim 1, wherein the substrate material is selected from the group comprising:
wood, particleboard, chipboard, plastic, metal and cellular materials.

6. An apparatus for laminating three-dimensional surfaces as described in claim 1, wherein the veneer material is selected from the group comprising:
wood, burl wood, plastic and metal.

7. An apparatus for laminating three-dimensional surfaces as described in claim 1, wherein the means for applying pressure to the top surface of the veneer to conform it to the substrate further comprises:
an airtight, flexible container, said flexible container having a sealable opening, said opening being sized and shaped to admit said substrate with said veneer disposed thereon;
means for evacuating the air from said container; and
whereby, when the substrate with the veneer disposed thereon is inserted into the container, the container sealed, and the air evacuated from the container, atmospheric pressure will conform the veneer to the upper surface of the substrate.

8. A method for laminating three-dimensional surfaces, comprising:
providing a substrate, said substrate being formed of rigid material, having an upper surface, a lower surface and a first perimeter;
forming three-dimensional features commencing at said upper surface, said three-dimensional features extending downwardly toward said lower surface;
providing a veneer, said veneer being formed of thin, resilient material and having a top surface and a bottom surface;
applying glue to the bottom surface of said veneer, said glue being suitable for adhering said veneer to said substrate;
positioning said veneer upon said substrate;
applying pressure to the top surface of said veneer to conform said veneer to said substrate; and
whereby, when said glue has dried, the veneer will be adhered to the upper surface of the substrate and will reflect the three-dimensional features of the substrate.

9. A method for laminating three-dimensional surfaces as described in claim 8, further comprising:
providing an airtight, flexible container, said flexible container having a sealable opening, said opening being sized and shaped to admit said substrate with said veneer disposed thereon;
inserting the substrate with the veneer disposed upon it into said flexible container;
sealing said container;
evacuating the air from said container;
allowing the glue to dry; and
removing the laminated substrate from the container.
